(19) United States
(12) Patent Application Publication
(10) Pub. No.: US 2006/0273585 A1
(43) Pub. Date: Dec. 7, 2006

(54) Flexible coupling of feed pipe

(76) Inventor: Chiu-Chih Chung, Chunghua Hsien (TW)

Correspondence Address: TROXELL LAW OFFICE PLLC, SUITE 1404, 5205 LEESBURG PIKE, FALLS CHURCH, VA, 22041, US

(21) Appl. No.: 11/143,621

(22) Filed: Jun. 3, 2005

(51) Int. Cl. F16L 19/00

(52) U.S. Cl. 285/354

(57) ABSTRACT

The improved flexible coupling the present invention provides is composed of a screw thread insert with an inlay edge extruded from its side and a T-shaped screw interlinked in the screw thread insert. In which, a non-thread section is designed at the ladder-shaped part of the T-shaped screw, and the screw thread insert is locked at the extruded part of the T-shaped screw from the screw thread insert with a rotary coupling after being interlinked with the T-shaped screw, and the non-thread section is exactly positioned on an inlay edge of the screw thread insert to form an idling and flexible coupling that turns between the T-shaped screw and screw thread insert at a non-screwing state. Although one more part is added (generally two parts) during the assembly, because the screw thread insert and the T-shaped screw are locked simply with a screw locker, and the added part is normal. Only small costs and work hours would be increased in the case of automatic process and production, but the convenient and quick operation, exemption from the process of punching rivet can be obtained besides its high safety.

### BACKGROUND OF THE INVENTION

1) Field of the Invention

The prevention invention provides an improved flexible coupling of feed pipe, in which a non-thread section is designed at the ladder-shaded part of a T-shaped screw, and after the interlinking and locking of the screw thread insert and the T-shaped screw with a rotary coupling, the non-thread section is exactly positioned on an inlay edge of the screw thread insert to form an idling and flexible coupling. Because the screw thread insert and the T-shaped screw are locked simply with a screw locker, and the added part is normal. Only small costs and work hours would be increased in the case of automatic process and production, but the convenient and quick operation, exemption from the process of punching rivet can be obtained besides its high safety.

2) Description of the Prior Art

Generally, the conventional flexible coupling, referring to the FIG. 1, mainly is composed of a screw thread insert 1 with an inlay edge 12 extruded from its side and a rotary coupling 3A designed in the screw thread insert 1. In which, after the rotary coupling 3A goes through the screw thread insert 1, the flexible coupling would be riveted by the end 31 of the rotary coupling 3A by means of punching to expand and embed the part of the rotary coupling 3A within the screw thread insert 1 and idle in the screw thread insert 1. However, because the flexible coupling should be embedded with a riveting machine, it is difficult to process it. Moreover, the costs and work hours would be increased. In view of the forgoing problem, the inventor of the present invention actively works with perseverance and develops this invention at last.

### SUMMARY OF THE INVENTION

The improved flexible coupling the present invention provides is composed of a screw thread insert with an inlay edge extruded from its side and a T-shaped screw interlinked in the screw thread insert. In which, a non-thread section is designed at the ladder-shaped part of the T-shaped screw, and the screw thread insert is locked at the extruded part of the T-shaped screw from the screw thread insert with a rotary coupling after being interlinked with the T-shaped screw, and the non-thread section is exactly positioned on an inlay edge of the screw thread insert to form an idling and flexible coupling that turns between the T-shaped screw and screw thread insert at a non-screwing state. Although one more part is added (generally two parts) during the assembly, because the screw thread insert and the T-shaped screw are locked simply with a screw locker, and the added part is normal. Only small costs and work hours would be increased in the case of automatic process and production, but the convenient and quick operation, exemption from the process of punching rivet can be obtained besides its high safety.

### BRIEF DESCRIPTION OF THE DRAWINGS

FIG. 1 is the plane sketch map of the prior flexible coupling.

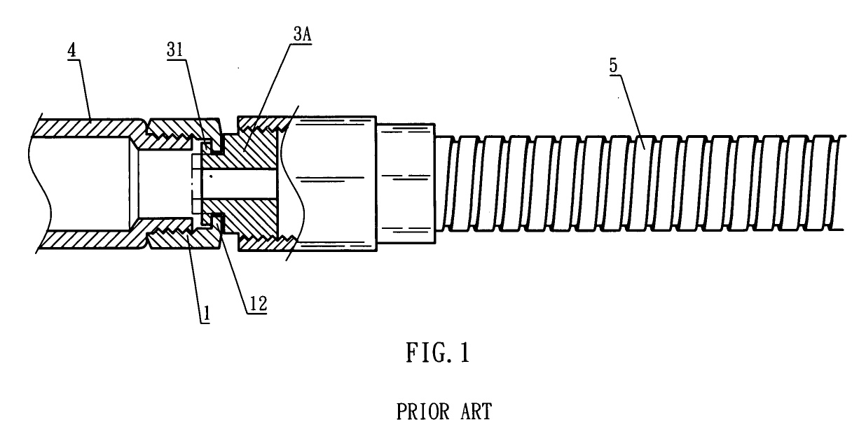

FIG. 2 is the three-dimensional exploded view of the present invention.

FIG. 3 is the plane cutaway view of the present invention.

### DETAILED DESCRIPTION OF THE PREFERRED EMBODIMENTS

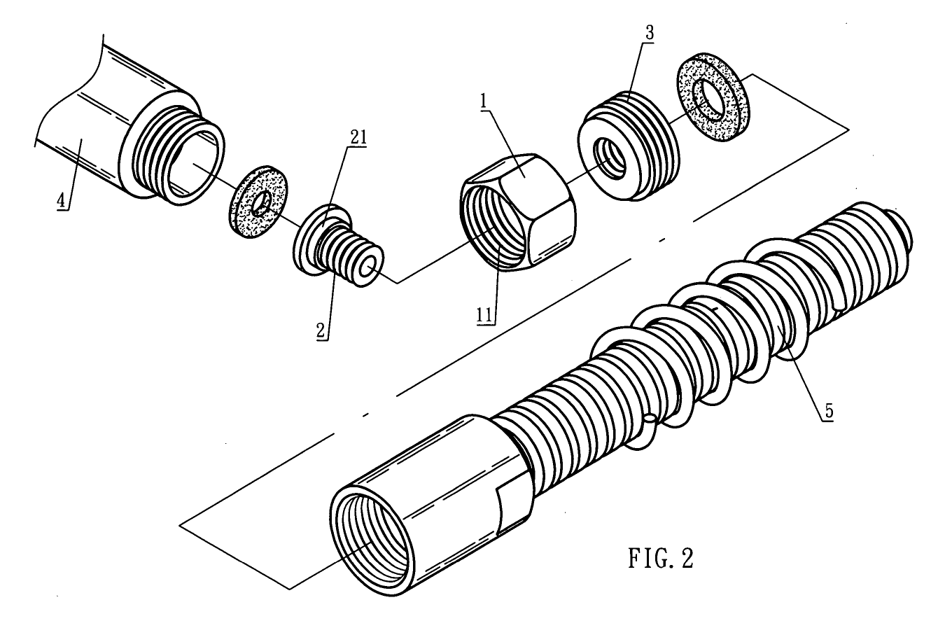

Referring to FIG. 2, the structure of the present invention can be saw clearly, comprising a screw thread insert 1, T-shaped screw 2 interlinked in the screw thread insert 1 and a rotary coupling 3 locked on the T-shaped screw 2, in which:

A screw thread surface 11 is designed in the screw thread insert 1 for locking the connecting pipe. And an inlay edge 12 is designed on the side of the screw thread insert 1, where the non-thread section 21 of the T-shaped screw 2 can hold;

And a non-thread section 21 is designed at the ladder-shaped part of a T-shaped screw 2, and after the interlinking and locking of the screw thread insert 1 and the T-shaped screw 2 with a rotary coupling, the non-thread section 21 is exactly positioned on an inlay edge 12 of the screw thread insert;

And the screw thread insert 1 is locked at the extruded part of the T-shaped screw 2 from the screw thread insert 1 with a rotary coupling after being interlinked with the T-shaped screw 2, and the non-thread section 21 is exactly positioned on an inlay edge 12 of the screw thread insert 1 to form an idling and flexible coupling that turns between the T-shaped screw and screw thread insert at a non-screwing state. And a flexible dividing pipe 5 is connected and locked on the rotary coupling 3;

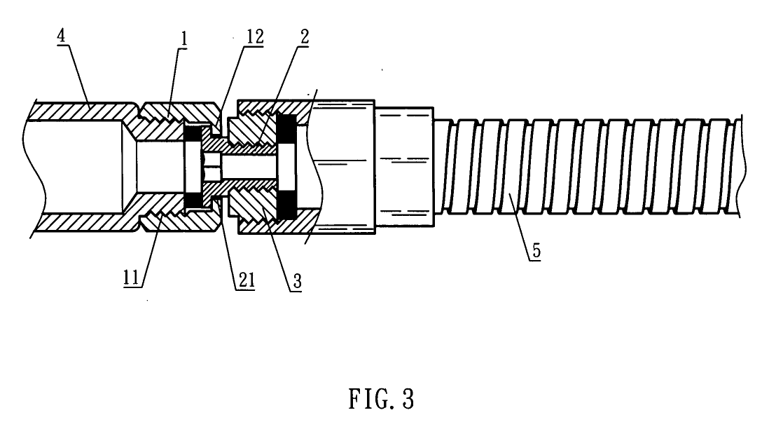

The assembly ways are as shown in FIG. 3, in which a non-thread section 21 is designed at the ladder-shaped part of the T-shaped screw 2, and after the T-shaped screw 2 goes through the screw thread insert land is locked by the rotary coupling 3 to fix the T-shaped screw 2 on the screw thread insert 1 and make the non-thread section 21 exactly positioned on an inlay edge 12 of the screw thread insert 1 to form an idling and flexible coupling that turns screw thread insert 1 at a non-screwing state for the T-shaped screw 2;

The present invention mainly provides flexible coupling, in which the T-shaped screw can be locked directly with the rotary coupling 3 after going through the screw thread insert to fix the T-shaped screw 2 on the screw thread insert 1 and idle, instead of the prior one, which is riveted on the screw thread insert directly with a rotary coupling. Although one more part is added (generally two parts) during the assembly, because the screw thread insert 1 and the T-shaped screw 2 are locked simply with a screw locker, and the added part (T-shaped screw) is normal. Only small costs and work hours would be increased in the case of automatic process and production, but the convenient and quick operation, exemption from the process of punching rivet can be obtained besides its high safety.

What is claimed is:

1. An improved flexible coupling of feed pipe comprises a screw thread insert, a T-shaped screw interlinked in the screw thread insert and a rotary coupling locked on the T-shaped screw. In which, an inlay edge is designed at the side of the screw thread insert while a non-thread section at its ladder-shaped part, and after the interlinking and locking of the screw thread insert and the T-shaped screw with a rotary coupling into one, the non-thread section is exactly positioned on an inlay edge of the screw thread insert to form an idling and flexible coupling turns between the T-shaped screw and screw thread insert at a non-screwing state. Therefore the convenient and quick operation and exemption from the process of punching rivet can be obtained besides its high safety can be achieved.
